(19) United States
(12) Patent Application Publication
(10) Pub. No.: US 2006/0080356 A1
(43) Pub. Date: Apr. 13, 2006

(54) System and method for inferring similarities between media objects

(75) Inventors: Chris Burges, Bellevue, WA (US); Cormac Herley, Bellevue, WA (US); John Platt, Redmond, WA (US)

Correspondence Address: MICROSOFT CORPORATION;C/O LYON & HARR, LLP, 300 ESPLANADE DRIVE, SUITE 800, OXNARD, CA, 93036, US

(73) Assignee: Microsoft Corporation, Redmond, WA (US)

(21) Appl. No.: 10/965,604

(22) Filed: Oct. 13, 2004

(51) Int. Cl. G06F 17/00

(52) U.S. Cl. 707/103 R

(57) ABSTRACT

A “similarity quantifier” automatically infers similarity between media objects which have no inherent measure of distance between them. For example, a human listener can easily determine that a song like Solsbury Hill by Peter Gabriel is more similar to Everybody Hurts by R.E.M. than it is to Highway to Hell by AC/DC. However, automatic determination of this similarity is typically a more difficult problem. This problem is addressed by using a combination of techniques for inferring similarities between media objects thereby facilitating media object filing, retrieval, classification, playlist construction, etc. Specifically, a combination of audio fingerprinting and repeat object detection is used for gathering statistics on broadcast media streams. These statistics include each media objects identity and positions within the media stream. Similarities between media objects are then inferred based on the observation that objects appearing closer together in an authored stream are more likely to be similar.

### BACKGROUND

1. Technical Field

The invention is related to inferring similarity between media objects, and in particular, to a system and method for using statistical information derived from authored media broadcast streams to infer similarities between media objects embedded in those media streams.

2. Related Art

One of the most reliable methods for determining similarity between two or more pieces of music is for a human listener to listen to each piece of music and then to manually rate or classify the similarity of that particular piece of music to other pieces of music. Unfortunately, such methods are very time consuming and are limited by the library of music available to the person that is listening to the music.

This problem has been at least partially addressed by a number of conventional schemes by using collaborative filtering techniques to combine the preferences of many users or listeners to generate composite similarity lists. In general, such techniques typically rely on individual users to provide one or more lists of music or songs that they like. The lists of many individual users are then combined using statistical techniques to generate lists of statistically similar music or songs. Unfortunately, one drawback of such schemes is that less well known music or songs rarely make it to the user lists. Consequently, even where such songs are very similar to other well known songs, the less well known songs are not likely to be identified as being similar to anything. As a result, such lists tend to be more heavily weighted towards popular songs, thereby presenting a skewed similarity profile.

Other conventional schemes for determining similarity between two or more pieces of music rely on a comparison of metadata associated with each individual song. For example, many music type media files or media streams provide embedded metadata which indicates artist, title, genre, etc. of the music being streamed. Consequently, in the simplest case, this metadata is used to select one or more matching songs, based on artist, genre, style, etc. Unfortunately, not all media streams include metadata. Further, even songs or other media objects within the same genre, or by the same artist, may be sufficiently different that simply using metadata alone to measure similarity sometimes erroneously results in identifying media objects as being similar that a human listener would consider to be substantially dissimilar. Another problem with the use of metadata is the reliability of that data. For example, when relying on the metadata alone, if that data is either entered incorrectly, or is otherwise inaccurate, then any similarity analysis based on that metadata will also be inaccurate.

Still other conventional schemes for determining similarity between two or more pieces of music rely on an analysis of the beat structure of particular pieces of music. For example, in the case of heavily beat oriented music, such as, for example, dance or techno type music, one commonly used technique for providing similar music is to compute a beats-per-minute (BPM) count of media objects and then find other media objects that have a similar BPM count. Such techniques have been successfully used to identify similar songs. However, conventional schemes based on such techniques tend to perform poorly where the music being compared is not heavily beat oriented. Further, such schemes also sometimes identify songs as being similar that a human listener would consider as being substantially dissimilar.

Another conventional technique for inferring or computing audio similarity includes computing similarity measures based on statistical characteristics of temporal or spectral features of one or more frames of an audio signal. The computed statistics are then used to describe the properties of a particular audio clip or media object. Similar objects are then identified by comparing the statistical properties of two or more media objects to find media objects having matching or similar statistical properties. Similar techniques for inferring or computing audio similarity include the use of Mel Frequency Cepstral Coefficients (MFCCs) for modeling music spectra. Some of these methods then correlate Mel-spectral vectors to identify similar media objects having similar audio characteristics.

Still other conventional methods for inferring or computing audio similarity involve having human editors produce graphs of similarity, and then using conventional clustering or multidimensional scaling (MDS) techniques to identify similar media objects. Unfortunately, such schemes tend to be expensive to implement, by requiring a large amount of editorial time.

Therefore, what is needed is a system and method for efficiently identifying similar media objects such as songs or music. Further, this system and method should approach the reliability of human similarity identifications. Finally, such a system and method should be capable of operation without the need to perform computationally expensive audio matching analyses.

### SUMMARY

A “similarity quantifier,” as described herein, operates to solve the problems identified above by automatically inferring similarity between media objects which have no inherent measure of distance between them. In general, the similarity quantifier operates by using a combination of media identification techniques to characterize the identity and relative position of one or more media objects in one or more media streams. This information is then used for statistically inferring similarity estimates between media objects in the media streams. Further, the similarity estimates constantly improve without any human intervention as more data becomes available through continued monitoring and characterization of additional media streams.

For example, in one embodiment, a combination of audio fingerprinting and repeat object detection is first used for gathering statistical information for characterizing one or more broadcast media streams over a period of time. The gathered statistics include at least the identity and relative positions of media objects, such as songs, embedded in the media stream, and whether such objects are separated by other media objects, such as station jingles, advertisements, etc. This information is then used for inferring similarities between various media objects, even in the case where particular media objects have never been coincident in any monitored media stream. The similarity information is then used in various embodiments for facilitating media object filing, retrieval, classification, playlist construction, automatic customization of buffered media streams etc.

In general, similarities between media objects are inferred based on the observation that objects appearing closer together in an authored media stream are more likely to be similar. For example, many media streams, such as, for example, most radio or Internet broadcasts, frequently play music or songs that are complementary to one another. In particular, such media streams, especially when the stream is carefully compiled by a human disk jockey or the like, often play sets of similar or related songs or musical themes. In fact, such media streams typically smoothly transition from one song to the next, such that the media stream does not abruptly jump or transition from one musical style or tempo to another during playback. In other words, adjacent songs in the media stream tend to be similar when that stream is authored by a human disk jockey or the like.

As noted above, the similarity of media objects in one or more media streams is based on the relative position of those objects within an authored media stream. Consequently, the first step performed by the similarity quantifier is to identify the media objects and their relative positions within the media stream. In one embodiment, identification of media objects within the media stream is explicit, such as by using either audio fingerprinting techniques or metadata for specifically identifying media objects within the media stream. Alternately, identification of media objects is implicit, such as by identifying each instance where particular media objects repeat in a media stream, without specifically knowing or determining the actual identity of those repeating media objects. Further, in one embodiment, the similarity quantifier uses a combination of both explicit and implicit techniques for characterizing media streams.

For example, a number of conventional methods use “audio fingerprinting” techniques for identifying objects in the stream by computing and comparing parameters of the media stream, such as, for example, frequency content, energy levels, etc., to a database of known or pre-identified objects. In particular, audio fingerprinting techniques generally sample portions of the media stream and then analyze those sampled portions to compute audio fingerprints. These techniques compute audio fingerprints which are then compared to fingerprints in the database for identification purposes. Endpoints of individual media objects within the media stream are then often determined using these fingerprints, metadata, or other cues embedded in the media stream. However, while object endpoints are determined in one embodiment of the similarity quantifier, as discussed herein, such a determination is unnecessary for inferring similarity between media objects. Note that conventional audio fingerprinting techniques are well known to those skilled in the art, and will therefore be described only generally herein.

With respect to identifying repeating media objects, there are a number of methods for providing such identifications. In general, these repeat identification techniques typically operate to identify media objects that repeat in the media stream without necessarily providing an identification of those objects. In other words, such methods are capable of identifying instances within a media stream where objects that have previously occurred in the media stream are repeating, such as, for example, some unknown song or advertisement which is played two or more times within one or more media streams. In this case, endpoints of repeating media objects may be determined using fingerprints, metadata, cues embedded in the stream, or by a direct comparison of repeating instances of particular media objects within the media stream to determine where the media stream around those repeating objects diverges. Again, it should be noted that such endpoint determination is not a necessary component of the similarity analysis performed by the similarity quantifier. As with audio fingerprinting techniques, techniques for identifying repeating media objects are well known to those skilled in the art, and will therefore be described only generally herein.

One advantage of using the repeat identification techniques discussed above is that an initial database of labeled or pre-identified objects (such as a predefined fingerprint database) is not required. In this case, simply identifying unique media objects within the media stream, and their relative positions to other media objects as they repeat in the stream allows for gathering of sufficient statistical information for determining media object similarity, even though the actual identity of those objects may be unknown. Further, the use of these repeat object identification techniques in combination with either or both predefined audio fingerprints or metadata information also allows otherwise new or unknown songs or music to be included in the similarity analysis with known songs or music.

Once the media stream has been characterized by either explicitly or implicitly identifying the objects and their positions within the media stream or streams, the next step is to statistically analyze the positional information of the media objects so as to infer their similarity to other media objects.

In general, the explicit or implicit identification of media objects within a media stream operates to create an ordered list of individual media objects, with each instance of those objects being logged. For example, if unique objects in the stream are denoted by {A, B, C, . . . }, a simple representation of the ordered list derived from a monitored media stream having a number of recurring media objects may be of the form[A B G D K E A B D H_FGSE_J K_ . . . ] where “_” is used to denote a break, or a time gap, in which no recognized media object was found, or in which an object is found, such as an advertisement, station jingle, etc., that provides little information regarding the similarity of any neighboring media objects. This ordered list is then used for identifying similarities between the identified media objects in the list using any of a number of statistical analysis techniques for processing ordered lists of objects.

For example, in one embodiment, the ordered list of objects is used to directly infer Probabilistic similarities by using k^{th} order Markov chains to estimate the probability of going from one media object to the next based on observations of the adjacency of k preceding media objects within the monitored media streams. A typical value of k in a tested embodiment ranges from about 1 to 3. The ordered list (or lists) is then searched for all subsequences of length k that matches the k previous objects played. Note that the use of such k^{th} order Markov chains are well known to those skilled in the art, and will not be described in detail herein.

In another embodiment, the ordered list of media objects is used to produce a graph data structure that reflects adjacency in the ordered list of media objects. Vertices in this graph represent particular media objects, while edges in the graph represent adjacency. Each edge has a corresponding similarity, which is a measure of how often the two objects are adjacent in the ordered list. This graph is then used to compute “distances” between media objects which correspond to media object similarity.

For example, in one embodiment, the adjacency graph uses conventional methods such as Dijkstra's minimum path algorithm (which is well known to those skilled in the art) to efficiently find the distance of each object represented in the adjacency graph to every other object in the adjacency graph by finding the shortest path from a point in a graph (the source) to every destination in the graph. Note that, in order to map the Markov chain, whose links identify transition probabilities between songs, to a graph in which links identify distances between adjacent nodes, the transition probabilities can, for example, be replaced by their negative logs; the sum of distances along a given path then represents the negative log likelihood of that sequence of songs. Such a mapping must be applied before applying the Dijkstra algorithm since that algorithm computes shortest paths.

In addition to the just described benefits, other advantages of the similarity quantifier will become apparent from the detailed description which follows hereinafter when taken in conjunction with the accompanying drawing figures.

### DESCRIPTION OF THE DRAWINGS

The specific features, aspects, and advantages of the similarity quantifier will become better understood with regard to the following description, appended claims, and accompanying drawings where:

FIG. 1 is a general system diagram depicting a general-purpose computing device constituting an exemplary system for automatically inferring similarity between media objects in a media stream.

FIG. 2 illustrates an exemplary architectural diagram showing exemplary program modules for automatically inferring similarity between media objects in a media stream, as described herein.

FIG. 3 illustrates an exemplary adjacency graph derived from one or more monitored media streams wherein vertices in the graph represent particular media objects, and edges in the graph represent adjacency and distance of those objects. In general such graphs can contain directed or undirected arcs.

FIG. 4 illustrates an exemplary operational flow diagram for automatically inferring similarity between media objects in a media stream, as described herein.

### DETAILED DESCRIPTION OF THE PREFERRED EMBODIMENTS

In the following description of the preferred embodiments of the present invention, reference is made to the accompanying drawings, which form a part hereof, and in which is shown by way of illustration specific embodiments in which the invention may be practiced. It is understood that other embodiments may be utilized and structural changes may be made without departing from the scope of the present invention.

1.0 Exemplary Operating Environment:

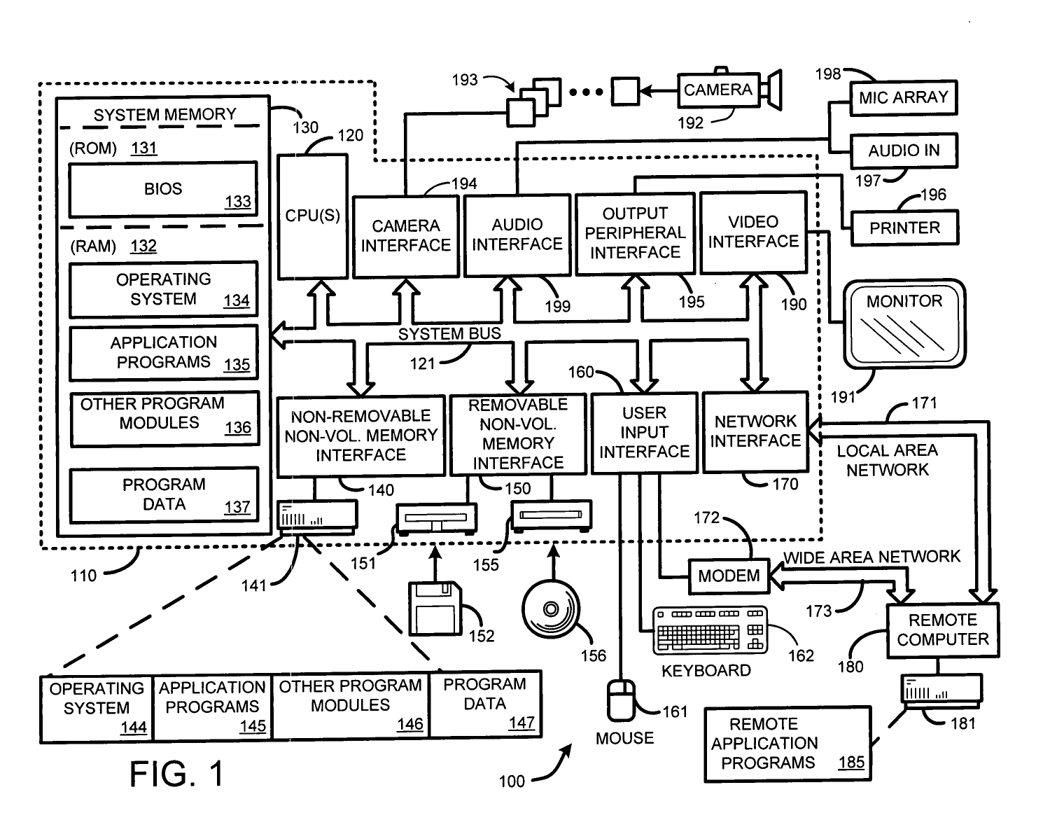

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held, laptop or mobile computer or communications devices such as cell phones and PDA's, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer in combination with hardware modules, including components of a microphone array 198. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices. With reference to FIG. 1, an exemplary system for implementing the invention includes a general-purpose computing device in the form of a computer 110.

Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile removable and non-removable media implemented in any method or technology for storage of information such as computer readable instructions, data structures, program modules, or other data.

Computer storage media includes, but is not limited to, RAM, ROM, PROM, EPROM, EEPROM, flash memory, or other memory technology; CD-ROM, digital versatile disks (DVD), or other optical disk storage; magnetic cassettes, magnetic tape, magnetic disk storage, or other magnetic storage devices; or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball, or touch pad.

Other input devices (not shown) may include a joystick, game pad, satellite dish, scanner, radio receiver/tuner, and a television or broadcast video receiver, or the like. These and other input devices are often connected to the processing unit 120 through a wired or wireless user input interface 160 that is coupled to the system bus 121, but may be connected by other conventional interface and bus structures, such as, for example, a parallel port, a game port, a universal serial bus (USB), an IEEE 1394 interface, a Bluetooth™ wireless interface, an IEEE 802.11 wireless interface, etc. Further, the computer 110 may also include a speech or audio input device, such as a microphone or a microphone array 198, or other audio input device, such as, for example, a radio tuner or other audio input 197 connected via an audio interface 199, again including conventional wired or wireless interfaces, such as, for example, parallel, serial, USB, IEEE 1394, Bluetooth™, etc.

A monitor 191 or other type of display device is also connected to the system bus 121 via an interface, such as a video interface 190. In addition to the monitor 191, computers may also include other peripheral output devices such as a printer 196, which may be connected through an output peripheral interface 195.

Further, the computer 110 may also include, as an input device, a camera 192 (such as a digital/electronic still or video camera, or film/photographic scanner) capable of capturing a sequence of images 193. Further, while just one camera 192 is depicted, multiple cameras of various types may be included as input devices to the computer 110. The use of multiple cameras provides the capability to capture multiple views of an image simultaneously or sequentially, to capture three-dimensional or depth images, or to capture panoramic images of a scene. The images 193 from the one or more cameras 192 are input into the computer 110 via an appropriate camera interface 194 using conventional interfaces, including, for example, USB, IEEE 1394, Bluetooth™, etc. This interface is connected to the system bus 121, thereby allowing the images 193 to be routed to and stored in the RAM 132, or any of the other aforementioned data storage devices associated with the computer 110. However, it is noted that previously stored image data can be input into the computer 110 from any of the aforementioned computer-readable media as well, without directly requiring the use of a camera 192.

The computer 110 may operate in a networked environment using logical connections to one or more remote computers, such as a remote computer 180. The remote computer 180 may be a personal computer, a server, a router, a network PC, a peer device, or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets, and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

The exemplary operating environment having now been discussed, the remaining part of this description will be devoted to a discussion of the program modules and processes embodying a system and method for automatically inferring similarity between media objects based on a statistical characterization of one or more media streams.

2.0 Introduction:

A human listener can easily determine that a song like Solsbury Hill by Peter Gabriel is significantly more similar to a song like Everybody Hurts by R.E.M. than either of those songs are to a song like Highway to Hell by AC/DC. However, automatically inferring similarity between such media objects is typically a difficult and potentially computationally expensive problem when addressed by conventional similarity analysis schemes, especially since media objects such as songs have no inherent measure of distance or similarity between them.

A “similarity quantifier,” as described herein, operates to automatically infer similarities between media objects monitored in one or more authored media streams through a statistical characterization of the monitored media streams. The inferred similarity information is then used in various embodiments for facilitating media object filing, retrieval, classification, playlist construction, etc. Further, the similarity estimates typically automatically improve as a function of time as more data becomes available through continued monitoring and characterization of the same or additional media streams, thereby providing more distance and adjacency information for use in inferring similarity estimates between media objects.

In general, the similarity quantifier operates by using a combination of media identification techniques to gather statistical information for characterizing one or more media streams. The gathered statistics include at least the identity (either explicit or implicit) and relative positions of media objects, such as songs, embedded in the media stream, and whether such objects are separated by other media objects, such as station jingles, advertisements, etc. This information is then used for inferring statistical similarity estimates between media objects in the media streams as a function of the distance or adjacency between the various media objects.

The inferential similarity analysis is generally based on the observation that objects appearing closer together in a media stream authored by a human disk jockey (DJ), or the like, are more likely to be similar. Specifically, it has been observed that many media streams, such as, for example, most radio or Internet broadcasts, frequently play music or songs that are complementary to one another. In particular, such media streams, especially when the stream is carefully compiled by a human DJ or the like, often play sets of similar or related songs or musical themes. In fact, such media streams typically smoothly transition from one song to the next, such that the media stream does not abruptly jump or transition from one musical style or tempo to another during playback. In other words, adjacent songs in the media stream tend to be similar when that stream is authored by a human DJ or the like.

For example, if Song A follows Song B in a media stream compiled by a human DJ, it is likely that Song B is similar to Song A. Such information can then be used to identify other similarities. For example, if Song B later follows Song C in the same or another media stream, then it is likely that Song A is also somewhat similar to Song C, even if Song A and Song C have never been played together in any monitored media stream.

When the physical separation between media objects increases, it can no longer be concluded that those objects are similar, but neither can it be concluded that they are completely dissimilar. Similarly, where intervening media objects, such as station jingles or identifiers, traffic reports, news clips, advertisements, etc., occur between any two songs or pieces of music, it can no longer be asserted with confidence that the objects are likely to be similar. All of these factors are considered in various embodiments, as described herein, for inferring similarity between media objects in one or more authored media streams.

2.1 System Overview:

As noted above, similarities between media objects are inferred based on the observation that objects appearing closer together in an authored media stream are more likely to be similar. Therefore, the relative position of media objects within the monitored media streams is an important piece of information used by the similarity quantifier. Consequently, the first step performed by the similarity quantifier is to identify the media objects and their relative positions within one or more authored media streams.

In one embodiment, identification of media objects within the media stream is explicit, such as by using either “audio fingerprinting” techniques or metadata for specifically identifying media objects within the media stream. Alternately, in another embodiment, identification of media objects is implicit, such as by identifying each instance where particular media objects repeat in a media stream, without specifically knowing or determining the actual identity of those repeating media objects. Further, in one embodiment, the similarity quantifier uses a combination of both explicit and implicit techniques for characterizing media streams.

Once the media stream has been characterized by either explicitly or implicitly identifying the media objects and their positions within the monitored media streams, the next step is to statistically analyze the positional information of the media objects so as to infer their similarity to other media objects.

In general, the explicit or implicit identification of media objects within a media stream operates to create an ordered list of individual media objects by logging each instance of those objects along with their relative position or time stamp within each monitored media stream. For example, if objects in the stream are denoted {A, B, C, . . . } a simple representation of the ordered list derived from a monitored media stream may be of the form [A B G D K E A B D H_F G S E_J K _ . . . ] where “_” is used to denote a break, or a time gap, in which no recognized media object was found, or in which an object is found, such as an advertisement, station jingle, etc., that provides little information regarding the similarity of any neighboring media objects.

This ordered list is then used for identifying or inferring similarities between the identified media objects in the list as a function of the adjacency or distance between any two or more objects. As noted above, this similarity information is then used for a number of tasks, including, for example, media object filing, retrieval, classification, playlist construction, automatic customization of buffered media streams, etc.

2.2 System Architecture:

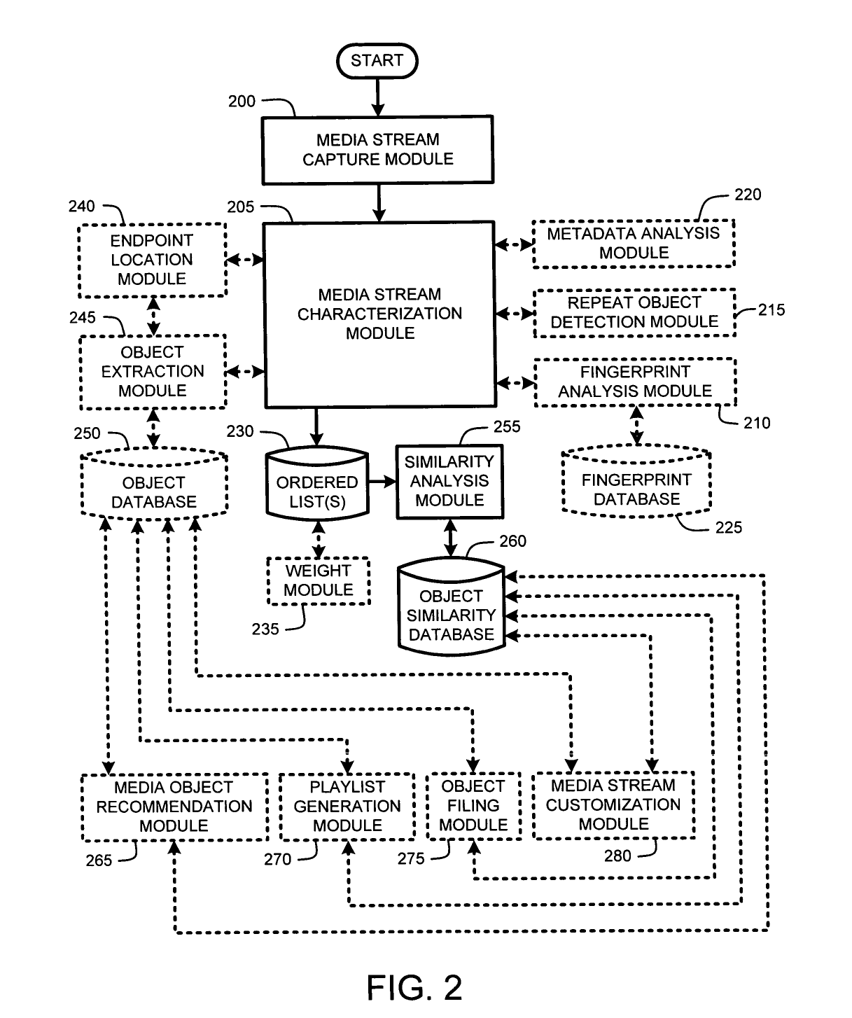

The following discussion illustrates the processes summarized above for automatically inferring similarity between media objects based on a statistical characterization of one or more media streams with respect to the architectural flow diagram of FIG. 2. In particular, the architectural flow diagram of FIG. 2 illustrates the interrelationships between program modules for implementing the similarity quantifier for automatically inferring similarity between media objects monitored in one or more authored media streams. It should be noted that the boxes and interconnections between boxes that are represented by broken or dashed lines in FIG. 2 represent alternate embodiments of the similarity quantifier, and that any or all of these alternate embodiments, as described herein, may be used in combination with other alternate embodiments that are described throughout this document.

In general, as illustrated by FIG. 2, the system and method described herein for automatically inferring similarity between media objects operates by automatically characterizing one or more monitored media streams by identifying media objects and their relative positions within those streams for use in an inferential similarity analysis.

Operation of the similarity quantifier begins by using a media stream capture module 200 for capturing one or more media streams which include audio information, such as songs or music, from any conventional media stream source, including, for example, radio broadcasts, network or Internet broadcasts, television broadcasts, etc. The media stream capture module 200 uses any of a number of conventional techniques to receive and capture this media stream. Such media stream capture techniques are well known to those skilled in the art, and will not be described herein.

As the incoming media stream is captured, a media stream characterization module 205 identifies each media object in the incoming media stream using one or more conventional object identification techniques, including, but not limited to, a fingerprint analysis module 210, a repeat object detection module 215, or a metadata analysis module 220. As discussed in further detail below in Section 3.1, the fingerprint analysis module compares audio fingerprints computed from audio samples of the incoming media stream to fingerprints in a fingerprint database 225. Further, also as discussed in Section 3.1, the repeat object detection module 220 generally operates by locating matching portions of the incoming media stream and then directly comparing those portions (or some low dimension version of the matching portions) to identify the position within the media stream where the matching portions of the media stream diverge so as to identify endpoints of the repeating media objects, and thus their relative positions within the media stream. Finally, the metadata analysis module 220 generally operates by simply reading the name or identify of each object in the media stream by interpreting embedded metadata (when it is available in the incoming media stream).

Regardless of which media object identification technique is employed by the media stream characterization module 205 to identify media objects and their position within the incoming media stream, the media stream characterization module then continues by generating an ordered list 230 of media objects for each incoming media stream received by the media stream capture module 200. Further, in one embodiment, one or more of the ordered lists 230, or objects within the ordered lists, are weighted, either positively or negatively, via a weight module 235.

For example, in one embodiment, the weight module 235 allows for one or more of the characterized media streams to be weighted so as to influence their overall contribution to the statistical similarity analysis. For example, in one embodiment, the object identification and positional information derived from two or more separate radio broadcasts, or portions of the same media stream authored by two unique DJ's is combined to create a set of composite statistics. Further, where a user prefers one station over another, or prefers one DJ over another, the statistics of the preferred media stream are weighted more heavily in combining the streams for performing the statistical similarity analysis. Similarly, this weighting can extend to individual media objects, such that particular media objects preferred or disliked by a user are weighted so as to influence their overall contribution to the statistical similarity analysis.

Once the ordered list or lists 230 have been computed for each incoming media stream, a similarity analysis module 255 then performs a statistical analysis of those ordered lists to infer similarity between the objects within the monitored media streams. In alternate embodiments, this statistical similarity analysis considers the relative positions of objects within the ordered lists as the basis for inferring similarity between objects.

For example, in one embodiment, the similarity analysis module 255 operates to infer probabilistic similarity estimates by using k^{th} order Markov chains, where the probability of going from one media object to the next (and thus whether one media object is similar to a preceding media object) is based on observations of k preceding media objects in the ordered list, as described in greater detail in Section 3.2.

In another embodiment, also discussed in greater detail in Section 3.2, the ordered list 230 of media objects is used to produce a graph data structure that reflects frequency of adjacency of particular media objects in the ordered list. The similarity analysis module 255 then operates to identify the distance from every media object in the ordered list 230 to every media object in the ordered list using an adaptation of a conventional technique such as Dijkstra's minimum path algorithm to identify the shortest paths from a given source to all other points in the graph. These shortest path distances are then used as similarity estimates, with shorter distances corresponding to greater similarity between any two media objects.

In fact, the Markov chain can be mapped to a graph for which links encode distances, and on which the Dijkstra algorithm can be applied, in a variety of ways. For example, in one embodiment, the probabilities associated with the links in the Markov chain are replaced by the negative log probabilities; the sum of distances along a given path then represents the negative log likelihood of that sequence of songs. In addition, the distance graphs considered may contain directed arcs, or may contain undirected arcs. In either case, the Dijkstra algorithm can be applied, since all distances are non-negative. The directed arcs in the Markov chain naturally result from the sequence in which the songs occur, and a directed distance graph can be converted to an undirected one by simply replacing the directed arcs by undirected arcs.

One advantage of using undirected distance graphs is that undirected graphs are more ‘connected’: for example, the simple directed graph with two songs, A→B, contains no information as to the similarity of A to B. Thus, either the adjacency of songs in the sequence can be used to compute a symmetric similarity measure, or the positions of songs in the sequence can additionally be used to compute an asymmetric similarity measure. The former can be used to compute similarities between any pair of songs between which a path in the graph exists (so that the similarity of A to B is the same as that of B to A); the latter can be used to compute asymmetric similarities (so that that graph retains the information that the probability that B follows A need not be the same as the probability that A follows B). For example, the asymmetric similarity will, when used to generate playlists by traversing the graph, better reflect the original sequence information.

In either case, whether using Markov models, or an adaptation of Dijkstra's minimum path algorithm to infer similarity between media objects, the similarity analysis module 255 then updates an object similarity database 260 which a listing of the inferred similarity of every identified media object to every other identified media object from the monitored media streams. Media stream capture and object identification continues as described above for as long as desired. Consequently, the ordered lists 230 continue to grow over time. As a result, the results of the similarity analysis tend to become more accurate as the length of each ordered list 230, and the number of ordered lists increases (if more than one stream is being monitored). This information is then used by the similarity analysis module 255 for continuing updates to the object similarity database 260 as more information becomes available. Consequently, the inferred similarity information contained in the object similarity database 260 tends to become more accurate over time, as more data is monitored. This inferred similarity information is then used for any of a number of purposes, such as, for example, media object filing, retrieval, classification, playlist construction, automatic customization of buffered media streams, etc.

For example, in one embodiment, an endpoint location module 240 is used to compute the endpoints of each identified media object. As with the initial identification of the media objects by the media stream characterization module 205, determination of the endpoint location for each identified media object also uses conventional endpoint isolation techniques. There are many such techniques that are well known to those skilled in the art. Consequently, these endpoint location techniques will be only generally discussed herein. One advantage of this embodiment is that media objects can then be extracted from the incoming media stream by an object extraction module 245 and saved to an object library or database 250 along with the identification information corresponding to each object. Such objects are then available for later use.

In particular, in one embodiment, a media recommendation module 265 is used in combination with the object database 250 and the object similarity database 260 to recommend similar objects to a user. For example, where the user selects one or more songs from the object database, the media recommendation module 265 will then recommend one or more similar songs to the user using the inferred similarity information contained in object similarity database 260.

In another embodiment, a playlist generation module 270 is used in combination with the object database 250 and the object similarity database 260 to automatically generate a playlist of some desired length for current or future playback by starting with one or more seed objects selected or identified by the user. The generated playlist will then ensure a smooth transition during playback between each of the media objects identified by the playlist generation module 270 since the media objects chosen for inclusion in the playlist are chosen based on their similarity.

For example, one conventional playlist generation technique is described in U.S. patent application Publication No. 20030221541, entitled “Auto Playlist Generation with Multiple Seed Songs,” by John C. Platt, the subject matter of which is incorporated herein by this reference. In general, the playlist system and method described in the referenced patent application publication compares media objects in a collection or library of media objects with seed objects (i.e., the objects between which one or more media objects are to be inserted) and determines which media objects in the library are to be added into a playlist by computation and comparison of similarity metrics or values of the seed objects and objects within the library of media objects. In this case, the playlist generation techniques described by the subject U.S. patent application Publication is simplified since the similarity values are already inferred by the similarity analysis module 255, as described above. Consequently, all that is required is for the user to simply select one or more seed songs to enable playlist generation.

However, the system described herein can also easily be used to generate playlists, by simply traversing the Markov chain, given a chosen starting (‘seed’) song. Whereas the prior art described above uses metadata to compute song similarity, the system described herein uses similarity derived from human-generated playlists, and the kinds of playlists that are generated by the two systems will be different. In particular, the playlists generated by the system described herein will more closely model the kinds of playlists generated by radio stations, and so will be more suitable for some applications (for example, for simulating a radio station, by combining the playlists of several real radio stations as described herein). Furthermore, the prior art playlist generator requires that humans label each song with metadata, which is both costly and error-prone.

It should be noted that where the user desires to actually play the media objects identified in the playlist, only those media objects available to the user, either locally or via a network connection of sufficient bandwidth, can actually be played back. Consequently, in one embodiment, the playlist generation module 270 will consider the available media objects when selecting similar objects to populate the playlist. Consequently, less similar objects may be selected in the case that more similar objects (as identified by the object similarity database 260) are not available to the user for playback.

In another embodiment, an object filing module 275 is used in combination with the object database 250 and the object similarity database 260 to automatically file media objects within groups or clusters of similar media objects. In general, this embodiment uses conventional clustering techniques for producing sets or clusters of similar media objects. These objects, or pointers to the objects, can then be stored for later selection or use. Consequently, in one embodiment, the object filing module 275 presents the user with the capability to simply select one or more clusters of similar music to play without having to worry about manually selecting the individual objects to play.

Finally, in yet another embodiment, a media stream customization module 280 is used in combination with the object database 250 and the object similarity database 260 to automatically customize buffered media streams during playback. For example, one such method for customizing a buffered media stream during playback is described in a copending patent application entitled “A SYSTEM AND METHOD FOR AUTOMATICALLY CUSTOMIZING A BUFFERED MEDIA STREAM,” having a filing date of TBD, and assigned Serial Number TBD, the subject matter of which is incorporated herein by this reference.

In general, a “media stream customizer,” as described in this copending patent application, customizes buffered media streams by inserting one or more media objects into the stream to maintain an approximate duration of buffered content. Specifically, given a buffered media stream, when media objects including, for example, songs, jingles, advertisements, or station identifiers are deleted from the stream (based on some user specified preference as to those objects), the amount of the stream being buffered will naturally decrease with each deletion. Therefore, over time, as more objects are deleted, the amount of the media stream being buffered continues to decrease, thereby limiting the ability to perform additional deletions from the stream. To address this limitation, the media stream customizer automatically chooses one or more media objects to insert back into the stream based on their similarity to any surrounding content of the media stream, thereby maintaining an approximate buffer size.

3.0 Operation Overview:

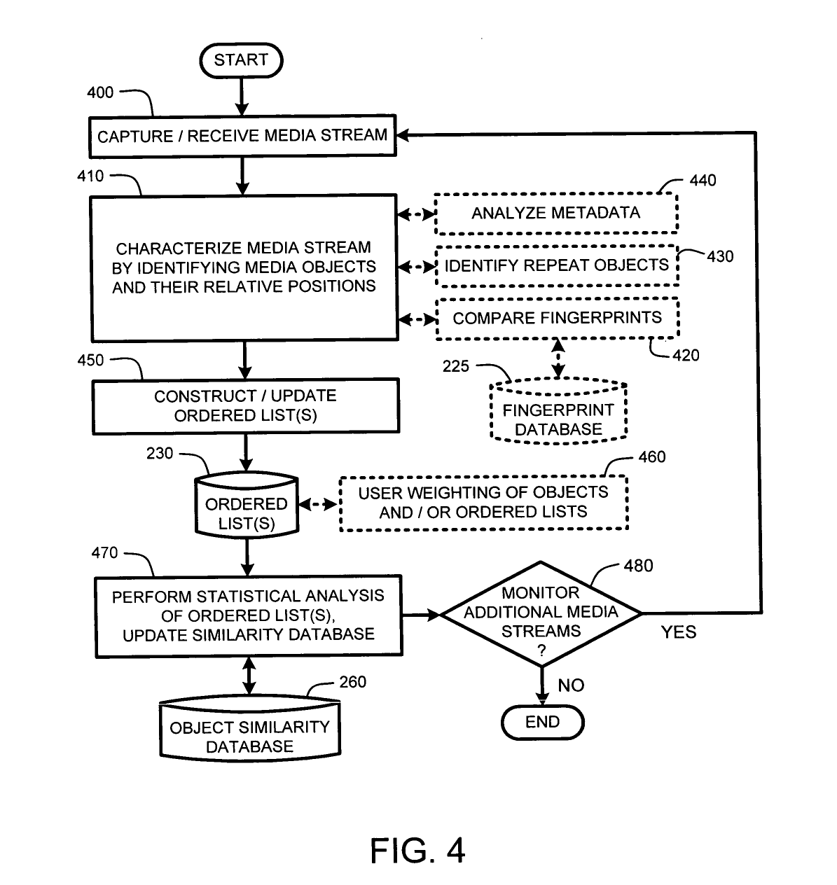

The above-described program modules are employed by the similarity quantifier for automatically inferring media object similarity from a characterization of one or more authored media streams. The following sections provide a detailed operational discussion of exemplary methods for implementing the aforementioned program modules with reference to the operational flow diagram of FIG. 4, as discussed below in Section 3.3.

3.1 Media Object Identification:

As noted above, media object identification is performed using any of a number of conventional techniques. Once objects are identified, either explicitly or implicitly, that identification is used to create the aforementioned ordered list or lists of media objects for characterizing the monitored media streams.

One conventional identification technique is to simply use metadata embedded in a monitored media stream to explicitly identify each media object in the media stream. As noted above, such metadata typically includes information such as, for example, artist, title, genre, etc., all of which can be used for identification purposes. Such techniques are well known to those skilled in the art, and will not be described in detail herein.

Another media object identification technique uses conventional “audio fingerprinting” methods for identifying objects in the stream by computing and comparing parameters of the media stream, such as, for example, frequency content, energy levels, etc., to a database of known or pre-identified objects. In particular, audio fingerprinting techniques generally sample portions of the media stream and then analyze those sampled portions to compute audio fingerprints. These computed audio fingerprints are then compared to fingerprints in the database for identification purposes. Such audio fingerprinting techniques are well known to those skilled in the art, and will therefore be discussed only generally herein.

Endpoints of individual media objects within the media stream are then often determined using these fingerprints, possibly in combination with metadata or other queues embedded in the media stream. However, as noted above, such endpoint determination is not a required component of the inferential similarity analysis. In fact, the endpoint determination is needed only where it is desired to make further use or characterization of the incoming media stream, such as, for example, by providing for media object filing, retrieval, classification, playlist construction, automatic customization of buffered media streams, etc., as described above.

Still other methods for identifying media objects in a media stream rely on an analysis of parametric information to locate particular types or classes of objects within the media stream without necessarily specifically identifying those media objects. Some of these techniques also rely on cues embedded in the media stream for delimiting endpoints of objects within the media stream. Such techniques are useful for identifying classes of media objects such as commercials or advertisements. For example commercials or advertisements in a media stream tend to repeat frequently in many broadcast media streams, tend to be from 15 to 45 seconds in length, and tend to be grouped in blocks of 3 to 5 minutes.

In this case, objects such as commercials, station identifiers, station jingles, etc., are identified only for the purpose of determining whether there is a gap or break between objects of greater interest (i.e., songs or music) in the media stream. Techniques for using such information to generally identify one or more media objects as simply belonging to a particular class of objects (without necessarily providing a specific identification of each individual object) are well known to those skilled in the art, and will not be described in further detail herein.

With respect to identifying repeating media objects, there are a number of lo conventional methods for providing such identifications. In general, these repeat identification techniques typically operate to implicitly identify media objects that repeat in the media stream without necessarily providing an explicit identification of those objects. In other words, such methods are capable of identifying instances within a media stream where objects that have previously occurred in the media stream are repeating, such as, for example, some unknown song or advertisement which is played two or more times within one or more broadcast media streams. Further, this embodiment can also be used in combination with metadata analysis, or with audio fingerprinting by simply computing audio fingerprints for otherwise unknown repeating objects and then adding those fingerprints to the fingerprint database along with some unique identifier for denoting such objects.

For example, one conventional system for implicitly identifying repeating media objects in one or more media streams is described in U.S. Pat. No. 6,766,523, entitled “System and Method for Identifying and Segmenting Repeating Media Objects Embedded in a Stream,” by Cormac Herley, the subject matter of which is incorporated herein by this reference. In general, the system described by the subject U.S. patent provides an “object extractor” which automatically identifies repeat instances of potentially unknown media objects such as, for example, a song, advertisement, jingle, etc., and segments those repeating media objects from the media stream. Specifically, the techniques described by the referenced U.S. patent implement a joint identification and segmentation of the repeating objects by directly comparing sections of the media stream to identify matching portions of the stream, and then aligning the matching portions to identify object endpoints. Then, whenever an object repeats in the media stream, it is identified as a repeating object, even if its actual identity is not known.

In this case, endpoints of repeating media objects may be determined, if desired, using fingerprints, metadata, cues embedded in the stream, or by a direct comparison of repeating instances of particular media objects within the media stream to determine where the media stream around those repeating objects diverges. Again, such identification techniques are well known to those skilled in the art, and will therefore be described only generally herein.

One advantage of using the repeat identification techniques discussed above is that an initial database of labeled or pre-identified objects (such as a predefined fingerprint database) is not required. In this case, simply identifying unique media objects within the media stream, and their relative positions to other media objects as they repeat in the stream allows for gathering of sufficient statistical information for determining media object similarity, even though the actual identity of those objects may be unknown. Further, the use of these repeat object identification techniques in combination with either or both predefined audio fingerprints or metadata also allows otherwise new or unknown songs or music to be included in the similarity analysis with known songs or music.

For example, in the case of the similarity quantifier described herein, each repeating object is simply assigned a unique identifier (which is the same for each copy of particular repeats) to differentiate it from other non-matching media objects in the ordered list of media objects derived from the monitored media streams. These unique identifiers are then used to identify similar media objects, either by explicit titles, when known, or by the automatically assigned unique identifiers where the explicit title is not known.

3.2 Media Similarity Analysis:

As noted above, the inferential similarity analysis operates based on the observation that objects appearing closer together in an authored media stream are more likely to be similar.

As noted above, in one embodiment, k^{th} order Markov chains are used to process the ordered list of objects derived from the monitored media streams. In this case, the probability of going from one media object to the next (i.e., the similarity) is based on observations of k preceding media objects. These probabilities can be considered to be asymmetric similarities between media objects. This concept is discussed in further detail below in Section 3.2.1.

In another embodiment, the ordered list of media objects is used to produce a graph data structure that reflects frequency of adjacency of particular media objects in the ordered list. In this case, the similarity between media objects is determined as a function of the distance between every object in the list, as returned by methods such as Dijkstra's minimum path algorithm which is used to identify the shortest paths from a given source to all other points in the graph. These shortest path distances are then used as similarity estimates, with shorter distances corresponding to greater similarity between any two media objects. This concept is discussed in further detail below in Section 3.2.2.

As noted above, the Markov chain embodiment is easily mapped to the shortest path embodiment, using a suitable mapping of similarities to distances.

In either case, whether using Markov chains, or an adaptation of Dijkstra's minimum path algorithm to infer similarity between media objects, the inferred similarity values are then stored to the aforementioned object similarity database. As noted above, this database continues to be updated as more information is made available through continued monitoring of media streams. Consequently, the similarity estimates tend to become more accurate over time.

3.2.1 Markov Chain Based Similarity Analysis:

As noted above, Markov chain analysis of the ordered list of objects is a useful method for inferring probabilistic asymmetric similarities between objects in an authored media stream. Such techniques for inferring probabilistic similarities between media objects are similar to well known Markov-chain-based techniques for generating random documents or word sequences (such as described in the well-known text book entitled “Programming Pearls, Second Edition” by Jon Bentley, Addison-Wesley, Inc., 2000). In general, such techniques are based on k^{th} order Markov chains, where the probability of going from one object to the next are based on observations of one or more preceding objects from a set of ordered objects. Note that the use of such k^{th} order Markov chains are well known to those skilled in the art, and will not be described in detail herein.

For example, in one embodiment, a playlist generator recommends or plays one object at a time. To determine the next similar song to be recommended or played, the k previous objects that were played are kept in a buffer. A typical value of k is 1 to 3. The ordered list (or lists) is then searched for all subsequences of length k that matches the k previous objects played. The next media object is then chosen at random from the objects that follow the matched subsequences. Further, in one embodiment, the search for such subsequences is accelerated through the use of conventional hash tables, as is known to those skilled in the art.

3.2.2 Adjacency Graph Based Similarity Analysis:

As noted above, in another embodiment, the ordered list of media objects is used to produce a graph data structure that reflects adjacency in the ordered list or lists of media objects. Vertices in this graph represent particular media objects, while edges in the graph represent adjacency. Each edge has a corresponding similarity, which is a measure of how often the two objects are adjacent in the ordered list.

For example, in the example ordered list described above, i.e., [A B G D K E A B D H_F G S E_J K_ . . . ] the vertex for B would be connected to the vertex for G and D (because G and D followed B at different points in the monitored media stream) and to the vertex for A (because A was a predecessor to B). The similarity of the B-G and B-D links would be 1 (because each link occurred once), while the B-A link would have similarity 2 (because B and A were adjacent twice).

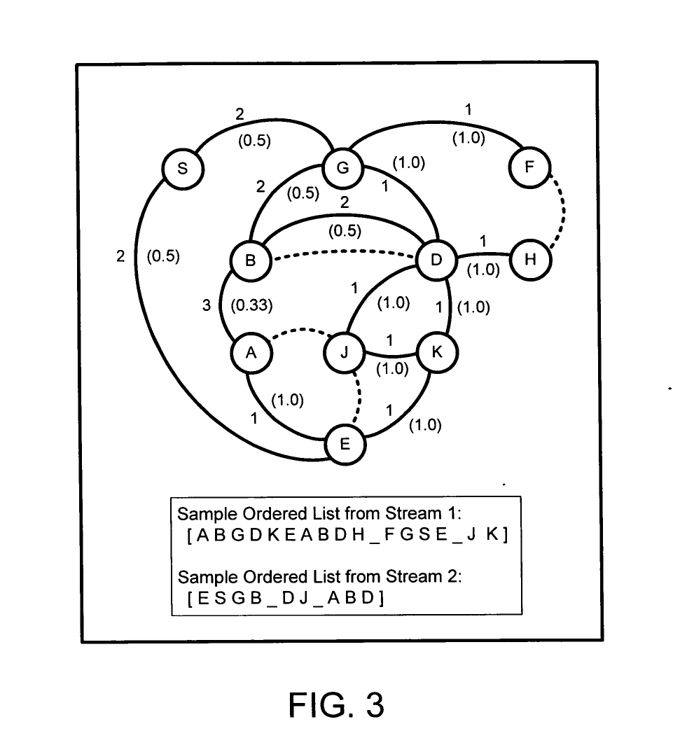

This concept is generally illustrated by FIG. 3, which provides a representation of an adjacency graph generated by a non-weighted combination of two ordered lists. Note that again, the directed arcs in the original Markov chain have been replaced by undirected arcs. Again, it should be noted that in alternate embodiments, either list, or objects within either list, may be positively or negatively weighted, as long as the final graph upon which the Dijkstra algorithm is run contains only non-negative distances. In particular, the first ordered list is given by: [A B G D K E A B D H_F G S E_J K]; and the second ordered list is given by: [E S G B_D J_A B D]. In this case, the breaks or a time gap between objects, denoted by “_” in each ordered list, are represented by the dashed lines in FIG. 3. Examples of such gaps or breaks can be seen in FIG. 3 in the B-D, A-J, E-J, and F-H links.

In the simplest case, any time that there is a gap or break between any media objects in the adjacency graph, no additional weight is assigned to the link between such objects (such as, for example the F-H link). As noted above, such breaks, or a time gap, represent sections of the media stream between two identified media objects wherein no recognized media object was found, or in which an object is found, such as an advertisement, station jingle, etc., that provides little information regarding the similarity of any neighboring media objects. However, it is not always the case that there is no similarity information that can be gleaned from the media stream in such cases.

Consequently, in one embodiment, the duration or type of gap or break is considered in determining whether two linked media objects should be assigned an adjacency value. For example, if there is a gap of a only a short period of time between two media objects, during which time the media stream contains no information, it is likely that the “dead air” represented by the gap is unintentional. In this case, the adjacent media objects are treated as if there was no gap or break, and assigned a full adjacency. Alternately, a partial or weighted adjacency score, such as, for example, a score of 0.5 (distance of 2.0) is assigned to the link, depending upon the duration and type of gap or break. For example, where the break or gap represents a relatively significant period of commercials or advertisements between two media objects of interest, than any adjacency score assigned to the media objects bordering the commercial period should be either zero or relatively low, depending upon the particular media stream being monitored.

In further embodiments, additional rules are used to produce more complicated adjacency graphs. For example, links between two media objects separated by one or more intermediate media objects (i.e., Song A and Song G separated by Song B) can also be created. In such an embodiment, the A-G link should be weighted less to reflect the fact that the two songs are not immediately adjacent. Further, as noted above, in one embodiment, particular media objects, such as a song that a particular user either likes or dislikes, can either be weighted with a larger or smaller value, thereby weighting all adjacency scores for links terminating at those objects. Similarly, in a related embodiment, particular media stream or streams that are either liked or disliked by the user, can also be weighted with a larger or smaller value. In this case, the contribution of every adjacency score from the corresponding ordered list is either increased or decreased in accordance with the assigned weighting.

In any case, once the adjacency graph is constructed, it is then used for inferring statistical similarities between the media objects represented by the adjacency graph. In general, once the graph is constructed, and the adjacencies converted to distances, conventional methods such as Dijkstra's minimum path algorithm are used to efficiently find a distance of each object in the graph to all other objects in the graph. Specifically, techniques such as Dijkstra's minimum path algorithm are useful for solving the problem of finding the shortest path from each point in a graph to every possible destination in the graph, with each of these shortest paths corresponding to the similarity between each of the objects.

For example, where the user wants to know what objects are similar to object A, the recommendation returned to the user by the similarity quantifier would be a list of objects, ordered by their distance to object A. Dijkstra's minimum path algorithm operates on distances, so the similarity on the graph needs to be transformed into distances. In one embodiment, this is achieved by simply defining the distances to be the reciprocal of the adjacency score. For example, an adjacency score of 3 would then be equivalent to a “distance” of ⅓. In another method, this is achieved by taking the negative log of the probabilities attached to the links in the Markov chain. Other methods of transforming adjacency scores into distances may also be used. For example, a number of these methods are described in the well-known text book entitled “Multidimensional Scaling” by T. F. Cox and M. A. A. Cox, Chapman & Hall, 2001.

In a related embodiment, the similarity quantifier operates on multiple inputs. In other words, rather than just identifying media objects that are similar to object X, for example, this related embodiment returns similarity scores based on a cluster or set of multiple objects (e.g., objects A, B, G, . . . ). In particular, in this embodiment, the similarity quantifier estimates the similarity of object X by first computing the graph distance of object X to each of the multiple objects A, B, G, etc. These distances are then combined to estimate the similarity of object X to the cluster or set of seed objects (A, B, G, . . . ).

One example of combining such distances is illustrated by Equation 1 below, which provides an optionally weighted sum of the reciprocal distances to each target object from a source object for estimating the similarity score for the source object to the set of target objects. Again, an algorithm such as Dijkstra's minimum path algorithm is quite useful for this purpose since it can be used to simultaneously compute a distance from one object to every other object in the graph. In particular, Equation 1 estimates a similarity between a source object and a set of n target objects as follows:

$$Similarity Score = {\sum }_{i = 1}^{n} \frac{1}{{d}_{i}} {ɛ}_{i} \qquad Equation 1$$

where ε is an adjustable weighting factor that can applied on a per object or per set basis, and dᵢ is the distance from the source object to the i^{th} target object. It should be clear that the method illustrated by Equation 1 is only one example of a large number of statistical tools that can be used to estimate the distance, and thus the similarity, from any one source object to a set of any number of target objects, and that the similarity quantifier described herein is not intended to be limited to this example, which is provided for illustrative purposes only.
3.3 System Operation:

As noted above, the similarity quantifier requires a process that first identifies media objects in one or more monitored media streams, and describes their relative positions in one or more ordered lists. Given these ordered lists, the similarity of each object in the list to every other object is then inferred using one or more of the statistical techniques described above. This inferred similarity information is then used for any of a number of purposes, including, for example, facilitating media object filing, retrieval, classification, playlist construction, automatic customization of buffered media streams etc., as discussed with respect to FIG. 2. These concepts are further illustrated by the operational flow diagram of FIG. 4 which provides an overview of the operation of the similarity quantifier.

It should be noted that the boxes and interconnections between boxes that are represented by broken or dashed lines in FIG. 4 represent alternate embodiments of the similarity quantifier, and that any or all of these alternate embodiments, as described herein, may be used in combination with other alternate embodiments that are described throughout this document.

In particular, as illustrated by FIG. 4, operation of the similarity quantifier begins by capturing one or more incoming media streams 400 using conventional techniques for acquiring or receiving broadcast media streams, including, for example, radio, television, satellite, and network broadcast receivers. As the media stream is being received 400, it is also being characterized 410 for the purpose of identifying the media objects, such as individual songs, and their relative positions within the media stream. Further, it should also be clear that the characterization 410 of the incoming media stream may be based on cached or buffered media streams in addition to live incoming media streams.

As described above, characterization 410 of the media stream by either explicit or implicit identification of media objects and their relative positions is accomplished using conventional media identification techniques, including, for example, computation and comparison of audio fingerprints 420 to the fingerprint database 225, identification of repeating objects 430 in the incoming media stream, and analysis of metadata embedded 440 in the media stream.

Once the incoming media stream has been characterized 410, one or more ordered lists representing the monitored media streams are constructed 450. Further, in the case where one or more media streams are monitored over a period of time, the ordered lists are simply updated 450 as more information becomes available via characterization 410 of the incoming media stream or streams. These ordered lists are then saved to a file or database 230 of ordered lists. In addition, as described above, in one embodiment, the user is provided with the capability to weight 460 either ordered lists 230 or individual objects within those lists, with a larger or smaller weight value.

It should also be noted that since these ordered lists are saved to a file or database 230, the operation of the similarity quantifier can also begin at this point. For example, if a monitored media stream results in the construction of an ordered list 230 that is particularly liked by the user (such as a broadcast by a favorite DJ), the user can save that ordered list for use in later similarity analyses. In addition, such ordered lists 230 can be saved, shared, or transmitted among various users, for use in other similarity analyses, either alone, or in combination with other ordered lists. As an extension of this embodiment, it should be clear that the user can save any number of ordered lists 230 corresponding to any number of favorite media stream broadcasts. Some or all of these ordered lists can then be selected or designated by the user and automatically combined as described herein, with or without weighting 460, so as to produce composite similarity results that are customized to the user's particular preferences.

In any case, given one or more ordered lists 230, the next step is to perform a statistical analysis 470 of those ordered lists for inferring the similarity between each object in the ordered lists relative to every other object in the ordered lists. A number of methods for performing this statistical similarity analysis 470 are described above in Section 3.2, and include probabilistic evaluation techniques including, for example, the use of Markov chains and adjacency graphs that are evaluated using Dijkstra's minimum path algorithm. Once inferred, the similarity values are stored to the object similarity database 260.

The processes described above then continue for as long as it is desired to continue monitoring 480 additional media streams. Further, as noted above, the values in the object similarity database 260 continue to be updated as more information becomes available through continued monitoring of the same or additional authored media streams.

The foregoing description of the invention has been presented for the purposes of illustration and description. It is not intended to be exhaustive or to limit the invention to the precise form disclosed. Many modifications and variations are possible in light of the above teaching. Further, it should be noted that any or all of the aforementioned alternate embodiments may be used in any combination desired to form additional hybrid embodiments of the systems and methods described herein. It is intended that the scope of the invention be limited not by this detailed description, but rather by the claims appended hereto.

What is claimed is:

1. A system for inferring similarities between media objects in an authored media stream, comprising using a computing device to:
identify media objects and relative positions of the media objects within at least one media stream;
generate at least one ordered list representing relative positions of the media objects within the at least one media stream;
infer a similarity score between a plurality of media objects as a function of the at least one ordered list.

2. The system of claim 1 wherein inferring a similarity score between a plurality of media objects further comprises:
constructing an adjacency graph from at least one of the ordered lists,
wherein vertices in the adjacency graph represent identified media objects and edges in the graph represent adjacency; and
using the adjacency graph for computing the similarity score between a plurality of media objects.

3. The system of claim 1 wherein identifying media objects and relative positions of the media objects within at least one media stream comprises analyzing metadata embedded in the media stream to explicitly determine the media object identities and relative positions within the stream.

4. The system of claim 1 wherein identifying media objects and relative positions of the media objects within at least one media stream comprises computing audio fingerprints from sampled portions of the at least one media stream and comparing the computed audio fingerprints to a fingerprint database to explicitly determine the media object identities and relative positions within the stream.

5. The system of claim 1 wherein identifying media objects and relative positions of the media objects within at least one media stream comprises locating repeating instances of unique media objects within the media stream and implicitly determining the media object identities and relative positions through a direct comparison of multiple portions of the media stream centered around the repeating instances of each particular unique media object within the stream.

6. The system of claim 1 further comprising automatically recommending media objects to a user by identifying a set of one or more media objects that are similar to a user selection of one or more media objects based on the inferred similarity scores.

7. The system of claim 1 further comprising using the inferred similarity scores for automatically generating a similarity-based media object playlist given one or more user selected seed media objects.

8. The system of claim 7, wherein automatically generating a similarity-based media object playlist comprises simulating a Markov chain.

9. The system of claim 1 further comprising automatically determining media object endpoints for the media objects identified in the at least one media stream.

10. The system of claim 9 further comprising copying at least one individual media object from the at least one media stream to a media object library along with the identity information of each copied media object.

11. The system of claim 10 further comprising using the inferred similarity scores for replacing at least one media object in an at least partially buffered media stream during playback of that media stream with at least one replacement media object from the media object library that is sufficiently similar to any media objects preceding or succeeding the at least one replacement media object.

12. The system of claim 1 further comprising weighting at least a portion of one of the ordered lists prior to inferring a similarity score between a plurality of media objects.

13. The system of claim 1 further comprising combining one or more of the ordered lists to create a composite ordered list prior to inferring a similarity score between a plurality of media objects.

14. A computer-readable medium having computer executable instructions for computing statistical similarity scores between discrete music objects in an authored media stream, comprising:
receiving at least one authored media stream containing at least some music objects;
identifying music objects and relative positions of each identified music object within the at least one authored media stream;
populating at least one ordered list with the identification and relative position information of the music objects; and
computing similarity scores for measuring a similarity between a plurality of identified music objects in the at least one authored media stream through a statistical analysis of the relative position information of the one or more identified music objects relative to each other of the one or more identified music objects.

15. The computer-readable medium of claim 14 wherein identifying music objects and relative positions of each identified music object within the at least one authored media stream comprises at least one of:
analyzing embedded metadata to explicitly determine the music object identities and relative positions;
comparing audio fingerprints from computed from samples of the at least one authored media stream to a fingerprint database to explicitly determine the music object identities and relative positions; and
implicitly determining unique music object identities and relative positions by locating repeating instances of the unique media objects within the media stream through a direct comparison of multiple portions of the media stream centered around repeating instances of each particular unique media object within the stream.

16. The computer-readable medium of claim 14 wherein computing similarity scores further comprises:
constructing an adjacency graph from at least one of the ordered lists, wherein vertices in the adjacency graph represent identified music objects and edges in the graph represent adjacency observations; and
computing the similarity scores between a plurality of music objects from the edges and vertices of the adjacency graph.

17. The computer-readable medium of claim 14 further comprising weighting at least a portion of one or more of the ordered lists.

18. The computer-readable medium of claim 16 further comprising weighting one or more of the edges of the adjacency graph.

19. The computer-readable medium of claim 14 further comprising using the similarity scores to generate musical playlists by simulating a Markov chain.

20. A computer-implemented process for inferring similarities between individual songs in broadcast media streams, comprising:
receiving at least one media stream broadcast;
explicitly identifying one or more songs within the at least one media stream through a comparison of sampled portions of the media stream to a fingerprint database comprised of information characterizing a set of known songs;
implicitly identifying one or more songs not already identified through the comparison to the fingerprint database by locating repeating instances of unique unidentified songs within the at least one media stream through a direct comparison of multiple portions of the at least one media stream centered around repeating instances of each particular unique unidentified song within the at least one media stream;
constructing at least one ordered list including at least the identity and a relative position of each explicitly and implicitly identified song; and
inferring a similarity score between a plurality of songs in each ordered list as a function of the at least one ordered list.

21. The computer-implemented process of claim 20 further comprising using available metadata for explicitly identifying songs that were not already identified, and including the identity and relative positions of the songs identified using the metadata in the at least one ordered list.

22. The computer-implemented process of claim 20 wherein inferring a similarity score between a plurality of songs in each ordered list further comprises:
constructing an adjacency graph from at least one of the ordered lists, wherein vertices in the adjacency graph represent identified songs and edges in the graph represent observations of adjacency between the identified songs; and
using the adjacency graph for inferring a similarity score between a plurality of songs in each ordered list.

23. The computer-implemented process of claim 20 further comprising weighting at least a portion of one or more of the ordered lists.

24. The computer-implemented process of claim 22 further comprising weighting one or more of the edges of the adjacency graph.

25. The computer-implemented process of claim 20 further comprising automatically recommending one or more songs to a user by identifying a set of one or more songs that are similar to a user selection of one or more songs based on the inferred similarity scores.

26. The computer-implemented process of claim 20 further comprising using the inferred similarity scores for automatically generating a similarity-based song playlist given one or more user selected seed songs.

27. The computer-implemented process of claim 26, wherein automatically generating a similarity-based song playlist comprises simulating a Markov chain.

28. The computer-implemented process of claim 20 further comprising automatically determining endpoints of the identified songs.

29. The computer-implemented process of claim 28 further comprising copying at least one individual song from the at least one media stream to a song library along with the identity information of each copied song.

30. The computer-implemented process of claim 29 further comprising using the inferred similarity scores for inserting one or more songs into a media stream by providing a least one inserted song which is sufficiently similar to any songs immediately preceding and immediately succeeding an insertion point in the media stream.
